(19) United States
(12) Patent Application Publication
(10) Pub. No.: US 2006/0080877 A1
(43) Pub. Date: Apr. 20, 2006

(54) Plastic sheet ESL holders

(76) Inventor: Michael G. Lowry, Boca Raton, FL (US)

Correspondence Address: Law Offices;Jacobson Holman, Professional Limited Liability Company, 400 Seventh Street, N.W., Washington, DC, 20004-2218, US

(21) Appl. No.: 11/248,584

(22) Filed: Oct. 13, 2005

Related U.S. Application Data
(60) Provisional application No. 60/618,132, filed on Oct. 14, 2004.

(51) Int. Cl. G09F 3/18

(52) U.S. Cl. 40/642.02

(57) ABSTRACT

An electronic shelf label (“ESL”) holder attachable to a merchandise display. The ESL holder includes an attachment portion and an integrally-formed display portion. The holder is formed of plastic sheeting. The display portion is an opening extending through the plastic sheeting that defines gripping elements to receive and support the ESL. The plastic sheeting is of substantially rigid PVC and the opening is a die-cut opening. Various gripping element embodiments are provided, including a linear edge, tabs, and flexible flaps. The attachment portion can include a sled for interengagement between product cases, loops, and rings.

This application claims the benefit of, and priority from, provisional application Ser. No. 60/618,132 filed Oct. 14, 2004.

### BACKGROUND OF THE INVENTION

1. Field of the Invention

This invention relates to electronic shelf label (“ESL”) holders for a variety of merchandise support structures and arrangements, such as stacked cartons, elongated strip merchandisers, wire shelves and baskets, and the like. More particularly, the present invention relates to a variety of ESL holders that are cut from a plastic sheet.

2. Description of the Related Art

Label holders for merchandise displays are well known in the art and take a variety of configurations. For example, flexible strip merchandisers or hang strips are well known in the art. See, U.S. Pat. No. 4,718,627, and the strip merchandiser with label as shown in Fast Industries Catalog 2000, pages 56-58, wherein die cut plastic sheets are formed into elongated strips with “V” or “W”-shaped slits to hold product, and wherein the upper portion of the strip, typically mounted on hooks or clips, includes a display area for a paper label with adhesive backing to provide purchasers with the unit price, promotional information, bar codes and other inventory control information. These plastic sheet strip merchandisers are relatively lightweight and formed from clear PVC, polypropylene, or polyethylene.

Another known label holder is the wire fixture label holder as shown in U.S. Pat. No. 4,869,007 and also shown in Fast Industries Catalog 2000, pages 24-25, which includes a rectangular-shaped planar face with tags that wrap around a wire rod forming from the merchandise shelf or basket. The face of the rectangular holder can include adhesive labels with bar codes or may even include a plastic overlay into which a paper product information label is inserted. Such information tags are relatively lightweight, formed from relatively thin plastic sheeting.

Another merchandising display system that is commonly used by retailers is to stack cartons of merchandise on the floor to form a display. Product within the cartons is sold out of the individual boxes. When the box is emptied after the products are sold out, the box is removed and the next lower box is opened for access by the purchasers. Typically, the retailer will cut out a portion of the top or front edge of the box to provide ready access to the merchandise. Recently, the boxes include tear perforations to enable a retailer to use the box as a display container. These are commonly known as cut case displays. Pricing and signage for the cut case displays are typically provided by use of a paper label attached to the box by a pressure-sensitive tape or glue.

Recently, electronic information carriers have been employed to provide product information. Electronic shelf labels (ESLs) are generally integrated with the in-store processor (ISP) or a free-standing controller that communicates with file information supporting the store's point-of-sale program. The ESL system may include low-voltage communication electronics or communication base stations (CBS) located in store ceilings away from the store operations. The ESLs are positioned throughout the store to identify an item's retail price and other information of interest to the consumer or for use by the store's inventory system.

Price changes may be initiated through the store's controller which updates item price files. This information, which has an association to a particular product identified by item number or UPC code, is communicated to the CBS in the ceiling and transmitted via a high frequency radio signal to the corresponding ESL. The ESLs are programmed with differing addresses that are also associated with the item number or UPC code of the product they represent. Once the addressed device is found, the label display changes and reflects an acknowledgment back to the CBS to confirm that the transmission was received and enacted. This acknowledgment is then communicated back to the ISP to complete the transaction. These systems, such as produced by NCR under its DecisioNet™ trademark, allow the ESLs to be independent of wires and cables below the ceiling, which reduces installation time and cost. Since there are no wires or cables required from the ceiling down, the label is free to be positioned anywhere. When store shelf resets occur, ESLs move easily with the shelves.

These ESL units, however, much like paper labels, require a carrier device to facilitate supporting them at selected locations, usually on the front of a store merchandise shelf. Several carriers for electronic shelf labels have been developed, including the device seen in U.S. Pat. No. 6,119,990, (the '990 patent). The '990 patent recognizes some of the problems associated with ESLs, with particular reference to adjusting the orientation of the carrier, and thus, the ESL, when it is secured directly to, for example, a C-channel at the front edge of a merchandise shelf or the like, to permit the viewer to more readily see the information, particularly if the electronic label is attached to a relatively low, or relatively high, shelf.

In commonly-assigned co-pending application Ser. No. 10/448,049 filed May 30, 2003, Publication No. 2004/0262470 published Dec. 30, 2004 (the '049 application), highly versatile carriers for ESLs are provided to enable one or more of such ESL devices to be positioned and repositioned in a simple and inexpensive manner. Such ESL carriers overcome many problems associated with the complexity and expense of the carrier of the '990 patent.

The ESL carriers of the '990 patent and the '049 application are not well adapted for supporting an ESL on die-cut plastic sheet label/merchandise holders. One effective ESL label holder associated with die-cut plastic sheet label holders is shown in co-pending commonly assigned patent application Ser. No. 10/922,164 entitled “Forwardly Extending Product Information Tags for Electronic Shelf Labels”, filed on Aug. 20, 2004, Publication No. 2005/0102874 published May 19, 2005, incorporated herein by reference. In the '164 application, a forwardly extending product identification and information tag for a merchandise support hook is shown wherein the distal end of the tag incorporates a means to simply and inexpensively receive and carry an ESL. The ESL is carried by a die-cut rectangular portion of different embodiments to support the ESL. Such embodiments include a flexible flap formed from the top edge of the rectangular cut-out to be inserted under a slotted area at the top of the back of a standard ESL. Such flap can be utilized with a pair of flexible tabs formed from the bottom rectangular portion, which tabs are to be inserted under the spring clips on the bottom of the back of a standard ESL. Further, the ESL could be retained by simply a rectangular cut-out without either the upper flexible flap or bottom flexible tabs, which rectangular cut-out is sized to receive the spring clips and slots of the standard ESL. As will be described, such arrangements can be utilized with the several embodiments of the present invention.

### SUMMARY OF THE INVENTION

It is a primary object of the instant invention to provide ESL holders for a variety of merchandising arrangements wherein the ESL holders are formed from plastic sheeting of various configurations. In particular, it is an object of one embodiment of the present invention to provide an ESL holder for stacks of boxed merchandise or cut case displays wherein the holder is a relatively thick plastic sheet having a wedge-shaped forward nose for insertion between adjacent stacked product cases and which is rugged enough to support large size ESLs.

A further object of this invention is to provide an ESL holder for strip merchandisers that hang from product hooks.

Still further, it is an object of the present invention to provide ESL label holders for merchandise information tags that are connected to wire racks or baskets.

### BRIEF DESCRIPTION OF THE DRAWINGS

These and other objects, features and many of the attendant advantages of the invention will be better understood upon a reading of the following detailed description when considered in connection with the accompanying drawings wherein:

FIG. 1 is a perspective view of a label holder in the form of a sled for retaining a large size ESL between stacked cartons of merchandise;

FIG. 2 is a front view of a large size ESL to be utilized with the label holder of FIG. 1;

FIG. 3 is a perspective view of the back of a large size ESL being attached to the ESL holder of FIG. 1;

FIG. 4 is a back or rear perspective view of the large size ESL holder attached to the sled of FIG. 1;

FIG. 5 is a close up view showing the upper flexible lip of the front face cut-out portion of the ESL holder interengaged with the upper slot on the battery pack of the ESL holder;

FIG. 6 is a perspective front view of the ESL label holder sled of FIG. 1 with the ESL attached thereto inserted into the stacks of boxed merchandise as used in a retail environment;

FIG. 7 is another embodiment of a die-cut ESL label holder for a strip merchandiser;

FIG. 8 is a close up perspective view of the strip merchandise holder of the present invention with the ESL about to be attached thereto;

FIG. 9 is a front perspective view of a strip merchandiser ESL holder with the ESL secured therewithin;

FIG. 10 is a perspective view of a merchandise information tag for an ESL used for wire racks, shelves, or baskets;

FIG. 11 is a perspective view of the merchandise information tag of FIG. 10 attached to a wire shelf with a small or standard size ESL secured thereto;

FIG. 12 is a perspective view of another embodiment of a merchandise information tag for wire racks using rings for attachment to the rack;

FIG. 13 is a front perspective view of the merchandise information label holder or tag of FIG. 12 with the ESL secured thereto;

FIG. 14 is a perspective view of a representative die-cut rectangular opening without flap or tabs in a display area for incorporation with an ESL holder; and

FIG. 15 is a perspective view of a representative die-cut rectangular opening with bottom tabs but without a flexible flap in a display area for incorporation with an ESL holder.

Like reference characters refer to like parts throughout the several views of the drawings.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

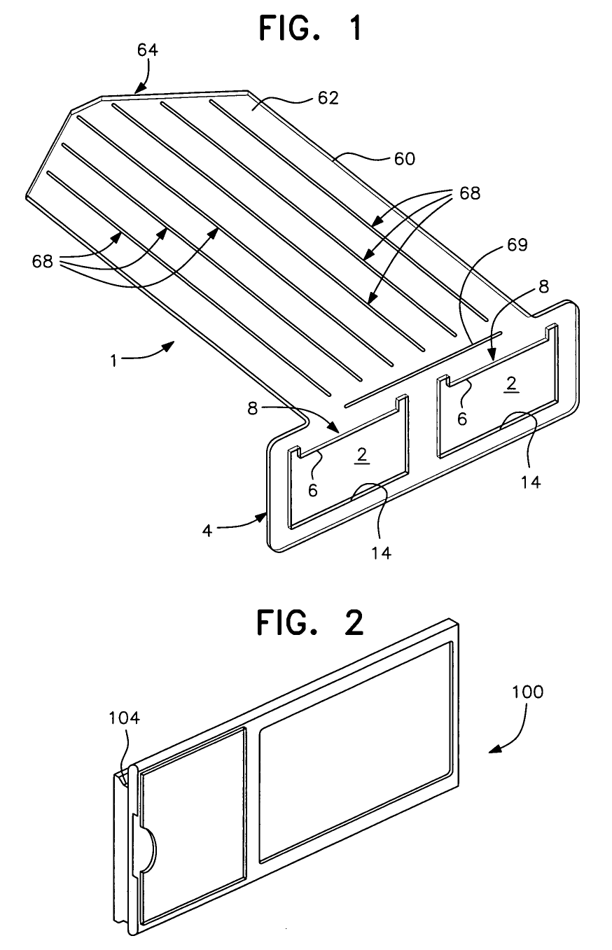

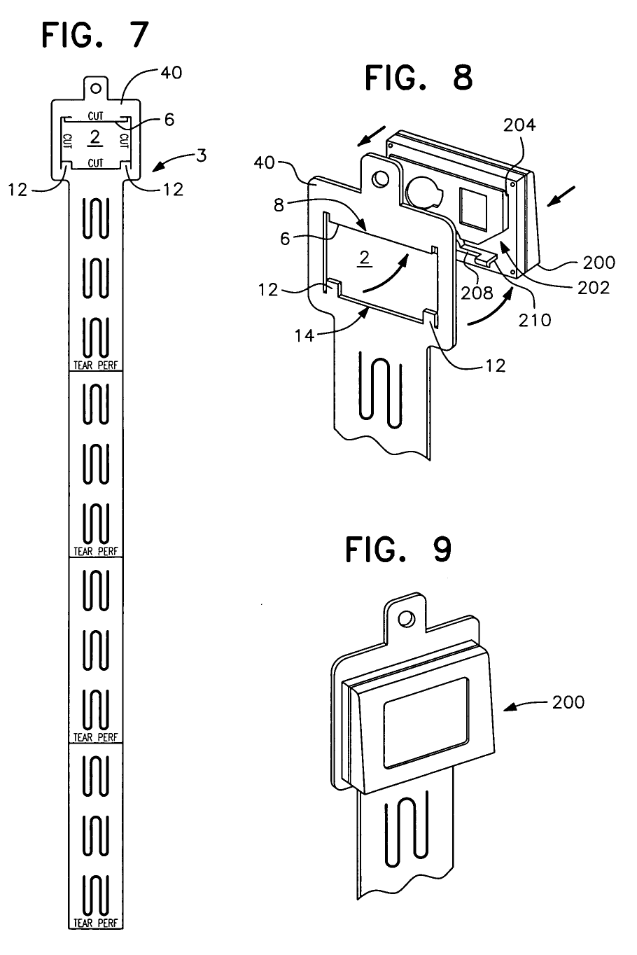

Before proceeding with a description of each of the several embodiments, the display area of the various label holders have several features in common that will be first discussed. As with the label holder described in the incorporated '164 application, the present invention relates to the die-cut opening in the display area of the label holder, which opening is adapted to support an ESL. In each of the embodiments, the display area of the label holder is die-cut to define an opening, or openings in the case of the FIG. 1 embodiment, for removably receiving an ESL as shown illustratively at 100 in the embodiments of FIGS. 1-6 and 200 in the embodiments of FIGS. 7-13.

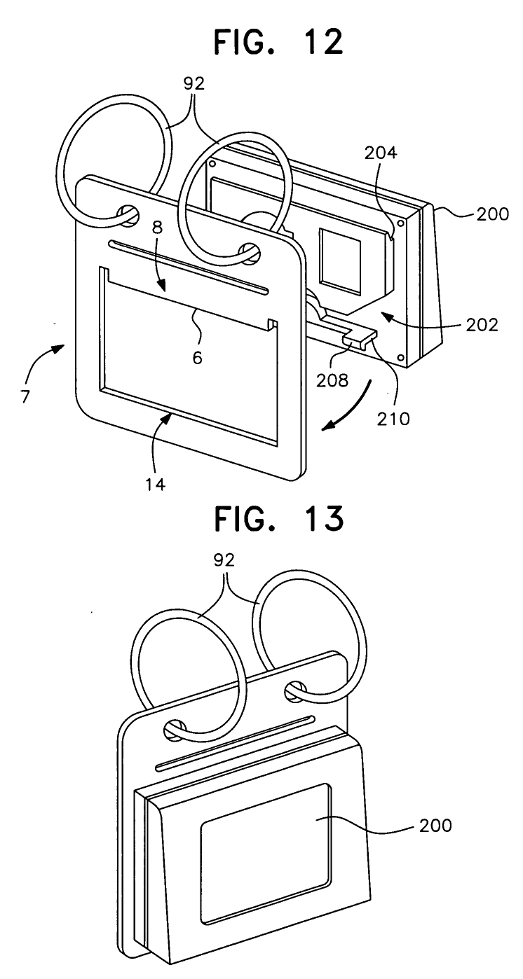

With respect to the ESL for the plastic sled embodiment, a large size ESL 100 is shown having a pair of side-by-side positioned generally rectangular bosses 102 on the rear of the ESL 100, each of which define an elongated slotted area 104 along its top edge, and includes a pair of spring clips 106, 108 defining grooves 110 thereunder. The bosses 102 include battery pack openings 112 for receiving batteries and/or other electronic components. In the standard size ESL 200 of the type shown in the FIGS. 7-13 embodiments, only a single boss 202 is included (see FIGS. 8 and 12). The single boss 202 includes an elongated slot 204 at the top edge and spring clips 208 (only one depicted) defining grooves 210. As can be seen, the large size ESL has the two bosses 102 which are substantially identical to the single boss 202 of the standard size ESL 200. Although the ESL itself forms no part of the present invention, and ESLs can vary in terms of their overall physical structure, ESLs will typically include an elongated slot at the upper region and a slot or groove at the lower region, in this case, the lower region slot or groove is defined by the spring clips.

A common feature of each of the embodiments is the die-cut generally rectangular opening or openings 2 within a relatively thin plastic sheet display area 4, 40 to receive and support the ESL. Several embodiments of the rectangular cut out portion 2 are possible. For example, with reference to the cut out areas 2 in FIG. 1, the display area 4 includes a generally rectangular cut out 2 with an elongated flexible flap 6 defined by the top edge 8 of the cut out. In the die cut opening 2 of FIGS. 8 and 10, the display area 40 includes a rectangular opening with an elongated flexible flap 6 formed from the top edge 8 and a pair of spaced, resilient tabs 12 at each of the lower corners from the bottom rectangular edge 14. In use, the tabs 12 are inserted into the grooves 210 under the spring clips 208 on the rear surface of the ESL 200 and the elongated flap 6 is engaged over the back of the ESL into the slotted area 204, thereby securing the ESL to the display portion 40 of the label holder. The relatively thin, resilient nature of the plastic sheet material from which the label holders 1, 3, 5, 7 are formed, facilitates resiliently engaging the tabs 12 and the flap 6 in the respective portions of the ESL. If desired, however, fold lines or the like (not shown) may be impressed into the display area of the label holder at the same time the opening 2 is die-cut therefrom to weaken those areas and facilitate engaging the tabs and flap with the ESL. Such fold lines could be used with the embodiment shown in FIGS. 1 and 12, wherein only the elongated upper flap 6 is shown without the use of the lower tabs 12.

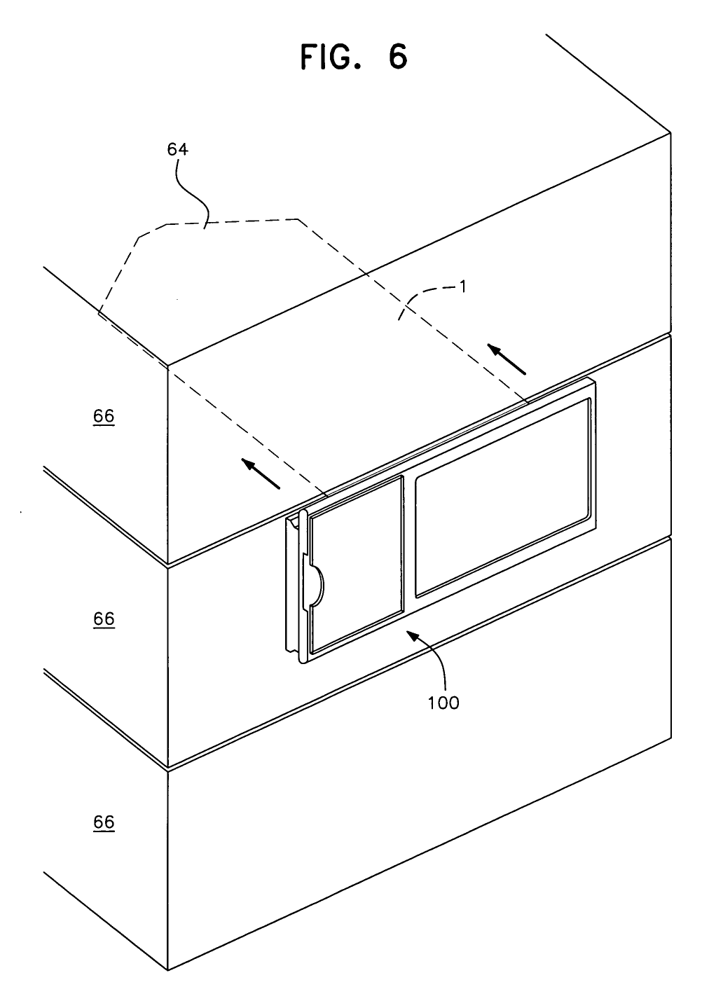

The die-cut opening 2 can be a simple rectangular opening 30 free of any tabs or flaps. See, FIG. 14 showing a display area 40. This is also described in the co-pending '164 application with reference to the FIG. 6 embodiment, incorporated by reference herein. The rectangular cut-out 30 is sized to receive the rectangular boss at the rear of the ESL, and the top edge 8 of the rectangle may fit within the slotted area of the ESL, wherein the bottom edge 14 of the rectangle is inserted into the grooves of the ESL. The distance between the top edge and bottom edge of the rectangle corresponds to the distance between the top of the tabs 12 to the free edge of the flap 6 in the embodiments shown in FIGS. 8 and 10. It should also be noted that the use of a rectangular opening or cut-out 30 may be sufficient to support the ESL by just supporting the boss portion without regard to the spring clips and grooves or the slotted area. That is, for ESLs that may have no grooves, either at the top or the bottom, but just a rectangular boss for receiving the battery, a rectangular die-cut portion can be sized to fit tightly over the boss to support the ESL.

Another embodiment of a die-cut generally rectangular opening is shown in FIG. 15 which includes the use of the lower tabs 12 without the upper edge flap. That is, the upper edge 8 is straight without a flap with the two tabs 12 extending from the adjacent corners of the bottom edge 14.

Thus, there are basically four different embodiments for the die-cut opening. The first is a plain, rectangular cut-out. See FIG. 14. This is the easiest to insert the ESL and, also, the easiest to remove the ESL. Next, in order of ease of insertion and removal, is a plain rectangle with a flap on the top edge. See FIGS. 1 and 12. Next, in order of ease of insertion and removal is a plain rectangle with just the tabs on the bottom. See FIG. 15. Finally, the most secure arrangement is the rectangle with the flexible flap on the top and the two tabs on the bottom edge. See FIGS. 8 and 10. Each of these die-cut openings can be used with any of the embodiments that will now be described.

Turning first to the embodiment of FIGS. 1-6, the label holder is a plastic product sled 1 that is die-cut from a piece 60 of plastic material, such as polyethylene, polypropylene, or PVC. In this embodiment, a large size ESL 100 is required to be supported and the ESL 100 is relatively heavy, requiring a relatively sturdy plastic sheeting 60. Preferably, the plastic sheeting 60 is a minimum of 0.030 inches. The product sled 1 includes a generally horizontal support sled 62 having a wedge-shaped free end 64 designed to assist in insertion of the label holder sled 1 between stacked cartons 66, as best shown in FIG. 6. Disposed within the support sled 62 are a plurality of matrix creases 68 lying along the length of the sled portion 62 that extends from the display area 4. These matrix creases 68 make the wedge shape sled 62 stronger and resistant to bending when the sled is inserted between the layers of cases. As is shown, at least six parallel creases 68 are provided for the requisite strength that is needed to support a large ESL. In addition, a matrix crease 69 is provided between the sled section 62 and the display portion 4 so as to assist in holding the two sections at right angles to each other. This folding may be done either with or without the application of heat.

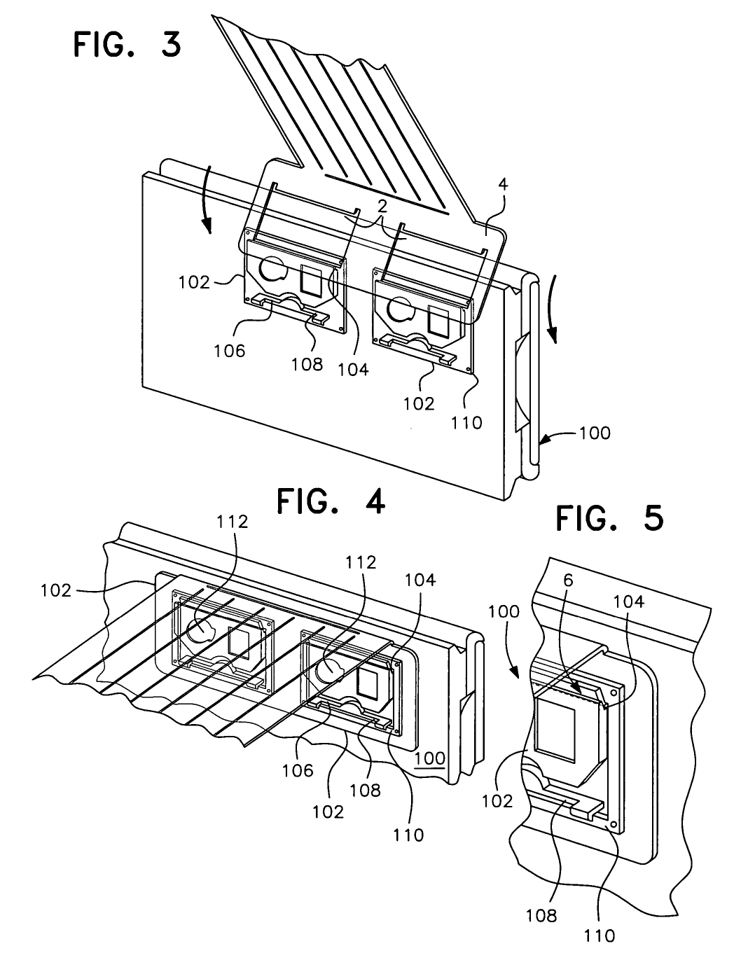

In use, the ESL 100 is mounted into the openings after the sled 1 takes its right angled configuration by first inserting the top edge flap 6 into the elongated slotted area 104 of the ESL bosses 100, and then moving the sled 1 and ESL 100 relative to each other to lock in the bottom edge 14 of the opening 2 to the lower slotted areas 110 of the ESL. FIG. 3 shows the insertion of the large ESL into the sled and FIG. 4 shows the completed assembly. FIG. 5 is a close up view of the edge that shows the flexible upper flap or lip 6 engaged to the upper elongated slotted area 104. Once the ESL 100 is attached, then the wedge-shaped end portion 64 is inserted between the layer of cases as far as it will go so that the ESL is on the outside of the display. See FIG. 6. As the products within the product case are sold, the sled is removed and reinserted between cases at a lower height.

Turning next to the embodiment of FIGS. 7-9, an elongated strip merchandiser 3 is depicted with a die-cut, generally rectangular, opening 2 in the label display area 40 of the merchandiser. Merchandisers with paper labels are well known in the art as previously discussed. This merchandising system is popular because multiple pieces of product can be displayed by hanging from a hook or spring clip whereby the displayed products take up no shelf space. The flexible strips 3 can be hung from the front or sides of shelves, wire displays, walls, or any open areas in the store giving added selling space where there was none before.

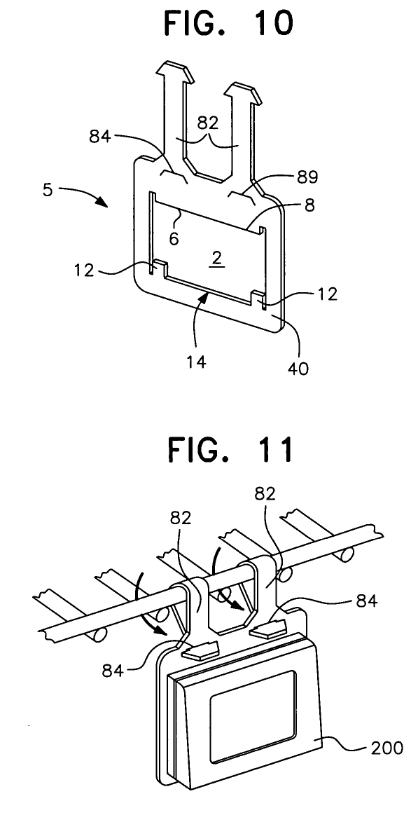

The label portion or display area 40 of the strip merchandiser includes a rectangular die-cut opening 2 for supporting the ESL 200. As shown in FIG. 7, the die-cut opening 2 is one with a flexible lip or flap 6 on the top edge of the rectangle with a pair of tabs 12 on each corner of the bottom edge of the rectangle. See FIGS. 7 and 8. The ESL, in this case a standard ESL 200, is secured to the rectangular opening in a manner as shown in FIGS. 8 and 9.

FIGS. 10 and 11 show ESL label holders 5 for wire shelves or baskets. In the embodiment of FIG. 10, a plastic wire fixture label holder 5 is shown with the general configuration as is known in the prior art, but now including the generally rectangular die-cut opening 2 to support the ESL. As shown in FIG. 10, the rectangular opening 2 has the flexible top lip or flap edge 6 with the pair of tabs 12 extending from the bottom edge 14 of the rectangular opening. After the ESL 200 is mounted as shown in FIG. 11, the plastic “arrows” 82 are looped around the wire and inserted through the slits 84 in the display portion to secure the label holder to the wire rod. Again, the opening 2 could be any of the four shapes as previously described but, preferably, the opening includes the flap on top and tabs at the bottom because this type of holder is more subject to abuse in use and will grip or hold the ESL tighter than the other embodiments.

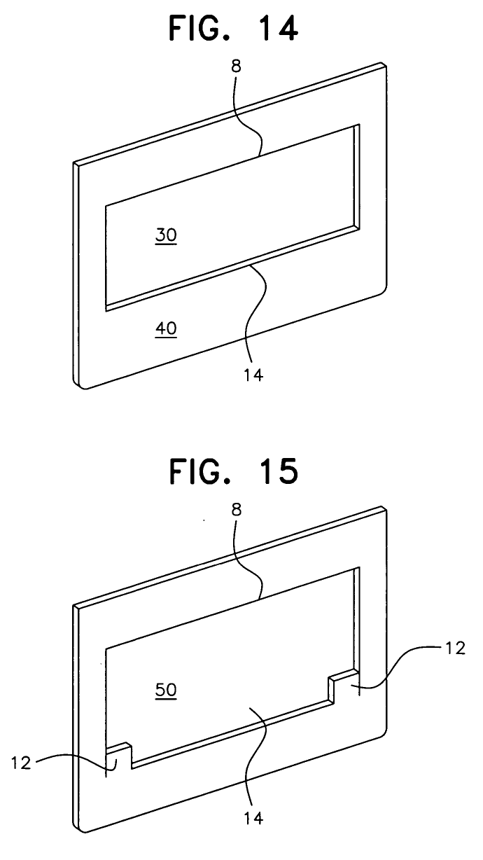

In the embodiment of FIGS. 12 and 13, another type of ESL holder 7 is shown for wire baskets and displays, but uses molded plastic rings 92 or similar rings, such as metal as is commonly used for key chains, which are inserted into holes at the top of the ESL holder. Each of the four die-cut opening embodiments can be utilized.

The foregoing descriptions and drawings should be considered as illustrative only of the principles of the invention. Numerous applications of the present invention will readily occur to those skilled in the art. Therefore, as noted above, it is not desired to limit the invention to the preferred embodiments or the exact construction and operation shown and described. Rather, all suitable modifications and equivalents may be resorted to, falling within the scope of the invention.

What is claimed is:

1. An electronic shelf label (“ESL”) holder attachable to a merchandise display comprising an attachment portion and an integrally-formed ESL display portion, said holder formed of plastic sheeting, said display portion including an opening through said plastic sheeting defining gripping elements to receive and support said ESL.

2. The ESL holder of claim 1 wherein said plastic sheeting is of substantially rigid PVC and said opening is a die-cut opening.

3. The ESL holder of claim 2 wherein said opening is substantially rectangular, said gripping elements defined by parallel opposed edges of said opening.

4. The ESL holder of claim 2 wherein said opening is substantially rectangular and said gripping elements include a flexible flap along a top edge of the opening and a pair of flexible tabs extending upward from the bottom edge of the opening.

5. The ESL holder of claim 2 wherein said opening is substantially rectangular and said gripping elements include a pair of flexible tabs extending upward from the bottom edge of the opening and the top edge of said opening is a linear edge.

6. The ESL holder of claim 2 wherein said opening is substantially rectangular and said gripping elements include a flexible flap along a top edge of the opening and the bottom edge of the opening is a linear edge.

7. The ESL holder of claim 1 wherein said attachment portion comprises an elongated substantially planar support sled with a plurality of parallel matrix creases formed therein and extending longitudinally in a direction from the display portion to a free end of said support sled, said display portion connected with said attachment portion through a matrix crease to enable the display portion to hang substantially perpendicular to said sled portion.

8. The ESL holder of claim 7 wherein said free end of said support sled is wedge-shaped so as to enable the support sled to be insertable between stacked cartons.

9. The ESL holder of claim 7 wherein said display portion includes a pair of openings.

10. The ESL holder of claim 7 wherein said plastic sheeting thickness is 0.030 inches or greater.

11. The ESL holder of claim 1 wherein said attachment portion comprises a hole adjacent said display portion opening for receiving a merchandise hook, said ESL holder further comprising a product supporting strip integrally formed with said display portion and coplanar therewith.

12. The ESL holder of claim 11 wherein said display portion opening lies between said hole and said product supporting strip.

13. The ESL holder of claim 1 wherein said attachment portion comprises a pair of plastic loop members integrally formed with said display portion for hanging said display portion from a wire shelf.

14. The ESL holder of claim 13 wherein each plastic loop member comprises an elongated arrow portion having a tip at its free end for insertion into a slit in the display portion.

15. The ESL holder of claim 1 wherein said attachment portion comprises a pair of rings.

16. A combined electronic shelf label (“ESL”) holder and an ESL removably supported thereby for attachment to a merchandise display, the combination comprising,
an ESL holder comprising an attachment portion and an integrally formed ESL display portion said holder formed of plastic sheet material, said display portion including an opening through said plastic sheet material defining gripping elements to receive and support said ESL;
an ESL having a front side for displaying information and a rear side including a boss portion for receiving batteries and/or other electronic components, wherein said gripping elements defined by said display portion receives and supports the ESL boss portion.

17. The combination of claim 16 wherein said opening is substantially rectangular having a top edge and bottom edge for gripping the ESL boss portion.
